(19) United States
(12) Patent Application Publication
(10) Pub. No.: US 2011/0303485 A1
(43) Pub. Date: Dec. 15, 2011

(54) Anti-slip Quick-connect Hardware

(75) Inventors: Felix Gauthier, Montreal (CA); Peter Ronald Bishop, Mississauga (CA); Laurent Payeur, Crabtree (CA)

(73) Assignee: Honeywell International Inc., Morristown, NJ (US)

(21) Appl. No.: 12/813,568

(22) Filed: Jun. 11, 2010

(51) Int. Cl. A44B 11/00; B21D 53/46; A62B 35/00

(52) U.S. Cl. 182/3; 29/3

(57) ABSTRACT

An anti-slip harness buckle element has a planar body portion with a plurality of slots formed therein. A biased, U-shaped, friction generating member is carried in one of the slots and slidably engages same. A portion of a support strap, or webbing extends through at least two of the slots of the buckle element and is in part forced toward an edge of one of the slots by the U-shaped, friction generating member thereby crating locking friction relative two the webbing to prevent slippage thereof.

### FIELD

The invention pertains to fall protecting harness assemblies. More particularly, the invention pertains to such assemblies that resist loosening or slipping from an initial adjustment.

### BACKGROUND

Various types of harness assemblies are known and used by first responders, construction, utility, industrial, oil rig, tower and elevated work platform workers as appropriate, depending on the circumstances. In addition for providing quick connect-type arrangements of various types so that no time is lost when arriving at a fire or other disaster, the harnesses are preferably quickly adjustable to suit different sizes of the responders.

In one known configuration 10, illustrated in FIGS. 1A, 1B a three bar adjustment element 12 carries a portion of webbing 14 of a harness. The webbing 14 is adjustable to draw tight a portion of webbing 18 which wraps around a square bar element 16 for a chest or leg length adjustment, for example.

It would be desirable if webbing elements 14, 18 in combination with the buckle assemblies 12, 16 maintained an adjustment when made by a responder when stepping into a harness in anticipation of addressing the fire or other disaster.

### BRIEF DESCRIPTION OF THE DRAWINGS

FIGS. 1A, 1B illustrate a prior art buckle/harness configuration;

FIGS. 2A and 2B taken together illustrate a buckle arrangement in accordance with the invention;

FIG. 3 illustrates a top view of a three bar buckle portion with a spring-loaded sleeve in accordance with the invention;

FIG. 4 illustrates the buckle of FIG. 3 combined with a portion of webbing for a harness;

FIG. 5 is a top plan view of a sleeve in accordance with the invention; and

FIG. 6 illustrates steps of a method in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

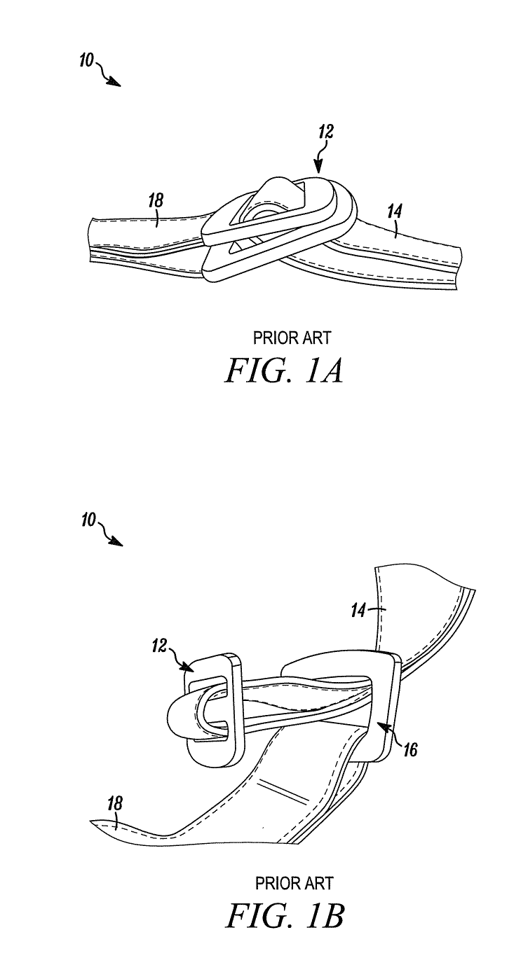

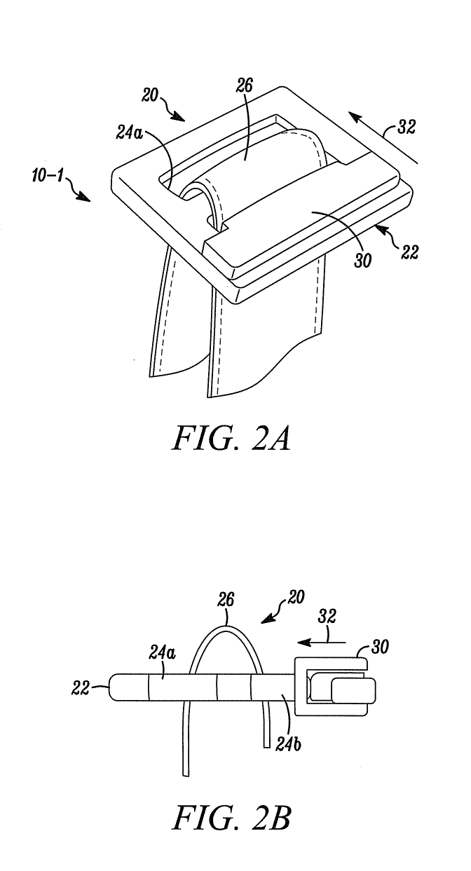

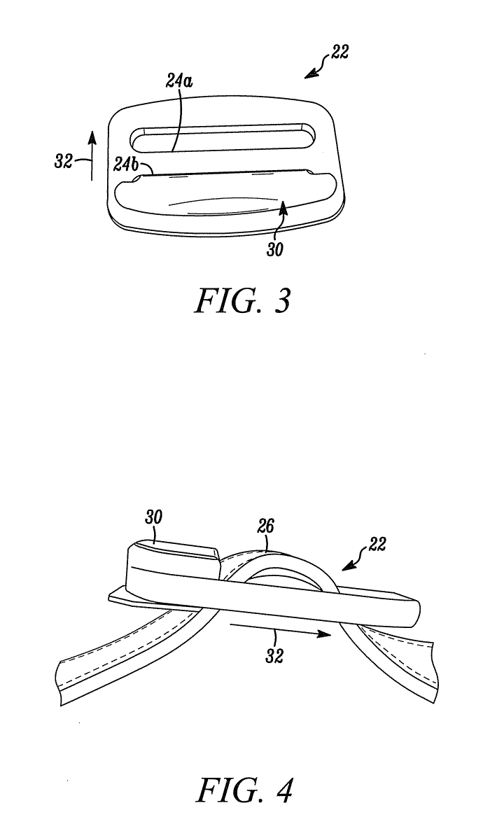

FIGS. 2A, 2B, 3 and 4 illustrate various aspects of a buckle element 10-1 in accordance with the invention. Those of skill will understand that the buckle element 10-1 would be used on combination with the square bar 16 and webbing 18 of FIGS. 1A, 1B. The buckle element 10-1, as explained below, provides a non-slip adjustment relative to the associated webbing to keep the respective harness from coming loose.

The element 10-1 includes a three bar portion 22 having slots 24a,b. The three bar portion 22 carries a spring biased sleeve 30 in one of the slots, such as 24b. The sleeve 30 pushes webbing 26 toward an edge of the slot 24b, in a direction 32. The increased friction provided by the interaction of the sleeve 30, side of the slot 24b with the webbing 26 creates friction on the webbing 26 to lock a preferred length adjustment made by a first responder in stepping into the respective harness.

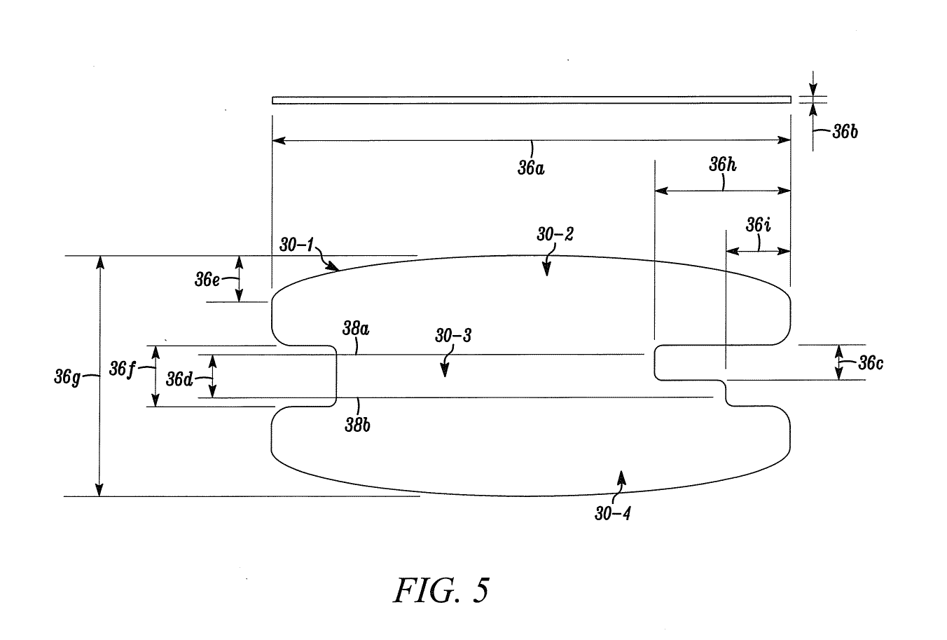

FIG. 5 illustrates details of the preferred shape of the sleeve 30. It will be understood that the shape of the sleeve 30 illustrated in FIG. 5 is exemplary only and variations thereof come within the spirit and scope of the invention.

Ellipse 30-1 from which sleeve 30 is fabricated, can be formed as a planar member having a predetermined length 36a, and thickness 36b, as would be understood by those of skill in the art, to be bendable, as discussed subsequently. The ellipse 30-1 has additional dimensions 36a . . . 36g also as would be understood by those of skill in the art.

The ellipse 30-1 when formed has two bends 38a, 38b which produce a three sided member having sides 30-2, 30-3, and 30-4 with a U-shaped cross-section as illustrated in FIGS. 2A, 4.

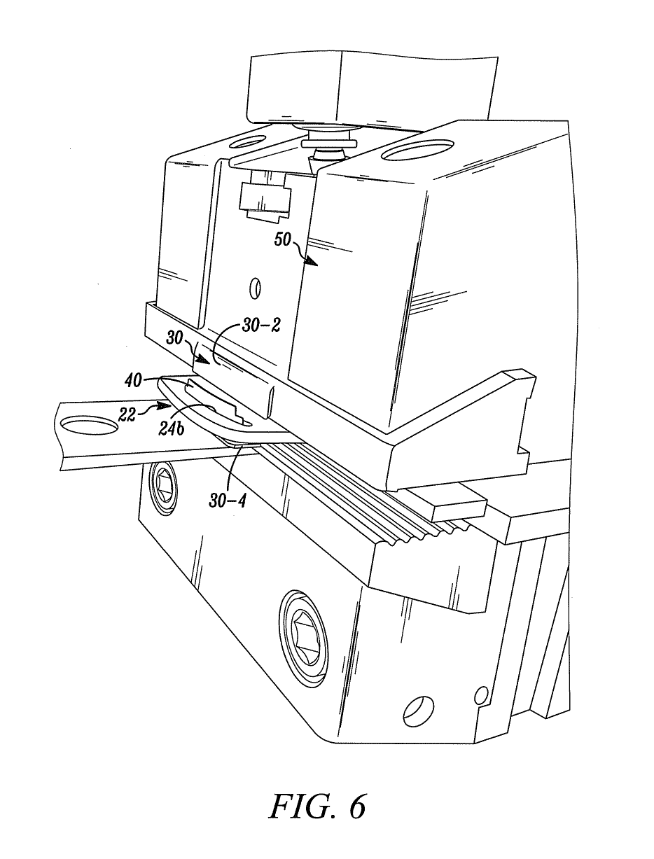

FIG. 6 illustrates aspects of a method of assembling the element 20. A tool 50 illustrates a partly formed element 22 which has been inserted into the tool 50. In accordance with the method, one side 30-4 is bent along the line 38b and then inserted into element 22 as illustrated in FIG. 6. A spring 40 can be inserted as illustrated in FIG. 6. A second bend is then made along the line 38a using the tool 50 to form the spring loaded sleeve 30 on the three bar element 22. The webbing, fabric element 26, can then be threaded through the slots 24a, 24b. The sleeve 30 then forces the webbing 26 in the direction 32 creating the desired, anti-slip friction.

It will also be understood that the ellipse 30-1 can be made from non-corrosive sheet metal. It could be punched out of the metal sheet or laser cut. End regions of the ellipse 10-1 can be shaped to facilitate insertion of the sleeve into the slot 24b of the 3 bar element 22.

The spring 40 can also be made out of non-corrosive sheet metal. The spring 40 could also be formed of plastic. Spring 40 preferably has a half-round shape.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An anti-slip harness assembly comprising:
a planar body portion which defines a plurality of elongated openings therethrough;
a section of webbing which extends through at least some of the openings; and
a biased anti-slip member which slidably engages a part of the body portion.

2. An assembly as in claim 1 where the openings defined by the body portion comprise a plurality of generally rectangular, spaced apart slots.

3. An assembly as in claim 1 where the member has at least first and second generally perpendicular sections.

4. An assembly as in claim 3 which includes a third section spaced from and generally parallel to the first section.

5. An assembly as in claim 4 which includes a biasing spring.

6. An assembly as in claim 5 where the spring is adjacent to each of the three sections.

7. An assembly as in claim 6 where the openings defined by the body portion comprise a plurality of generally rectangular, spaced apart slots.

8. An assembly as in claim 7 where the webbing extends at least through two of the slots.

9. An assembly as in claim 8 where the member has a generally U-shaped cross-section.

10. An assembly as in claim 9 where a curved spring is located adjacent to first and second sides of the member.

11. An assembly as in claim 8 where the spring is adjacent to all sides of the member.

12. An assembly as in claim 11 where the member is biased by the spring to push an adjacent portion of the webbing toward a slot bounding surface of the body portion.

13. An assembly as in claim 12 where the spring can be formed of one of metal or plastic.

14. An assembly as in claim 13 where the spring has a curved shape.

15. An assembly as in claim 2 where the member has an elliptical, planar shape.

16. An assembly as in claim 14 where the member has an elliptical, planar shape prior to being formed with the U-shaped cross-section.

17. A method of forming an anti-slip harness buckle comprising:
providing a multi-slotted planar, buckle member;
providing an elliptically shaped planar, locking member;
bending a first portion of the planar locking member along a region parallel to a major axis thereof;
inserting the bent elliptically shaped locking member into one of the slots;
inserting a spring into the slot; and
bending a second portion of the locking member along a region parallel to the major axis to form a biased sleeve having a U-shaped cross-section.

18. A method as in claim 17 which includes sliding a webbing through at least two of the slots, where one of the slots carries the planar locking member and forcing the webbing against a portion of the one slot.
